(19) United States
(12) Patent Application Publication
(10) Pub. No.: US 2026/0326638 A1
(43) Pub. Date: Oct. 22, 2026

(54) MASSAGE SEAT

(71) Applicant: Julian Jones, SR., Ofallon, IL (US)

(72) Inventor: Julian Jones, SR., Ofallon, IL (US)

(21) Appl. No.: 19/185,927

(22) Filed: Apr. 22, 2025

(51) Int. Cl. B60N 2/56; B60N 2/90

(52) U.S. Cl. CPC B60N 2/5642; B60N 2/5685; B60N 2/976

(57) ABSTRACT

A massage seat includes a seat body, a plurality of massagers, a heating and cooling system, a microprocessor, a wired control module, a transceiver, a remote control module, and a power supply unit. The seat body is designed to be placed on a vehicle seat or a chair. The heating and cooling system includes air channels positioned in the seat body and each having an air inlet and an air outlet, at least one fan designed to circulate air through the air channels, and at least one heating element designed to selectively heat the air in the air channels. The wired control module is connected to the microprocessor to selectively control the massagers and the heating and cooling system. The remote control module is wirelessly connected to the microprocessor by the transceiver to selectively control the massagers and the heating and cooling system.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND ART

### (1) Field of the Invention

The disclosure relates to massage seat covers and more particularly pertains to a new massage seat for providing a variety of control options and other features to provide massage, heating, and cooling effects.

(2) Description of Related Art including information disclosed under 37 CFR 1.97 and 1.98.

The prior art relates to seat massagers for use in vehicles and at home. The prior art, as best understood, does not disclose massage seat for a vehicle seat or chair having massagers and a heating and cooling system which can be controlled using a remote control module and a wired control module.

### BRIEF SUMMARY OF THE INVENTION

An embodiment of the disclosure meets the needs presented above in a massage seat generally comprising a seat body, a plurality of massagers, a heating and cooling system, a microprocessor, a wired control module, a transceiver, a remote control module, and a power supply unit. The seat body is designed to be placed on a vehicle seat or a chair. The massagers are positioned in the seat body. The heating and cooling system includes air channels positioned in the seat body and each having an air inlet and an air outlet, at least one fan designed to circulate air through the air channels, and at least one heating element designed to selectively heat the air in the air channels. The microprocessor is connected to the massagers and the heating and cooling system. The wired control module includes a housing and a cable connecting the housing to the seat body. The wired control module is connected to the microprocessor to selectively control the massagers and the heating and cooling system. The transceiver is connected to the microprocessor. The remote control module is wirelessly connected to the microprocessor by the transceiver to selectively control the massagers and the heating and cooling system. The power supply unit is connected to the massagers, the heating and cooling system, the microprocessor, and the wired control module to supply power.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a massage seat according to an embodiment of the disclosure.

FIG. 2 is a front view of an embodiment of the disclosure.

FIG. 3 is a rear view of an embodiment of the disclosure.

FIG. 4 is a cross-sectional view of a component of the embodiment of the disclosure in FIG. 2.

FIG. 5 is a top view of an embodiment of the disclosure in use.

FIG. 6 shows a block diagram of components of an embodiment of the disclosure.

### (j) DETAILED DESCRIPTION OF THE INVENTION

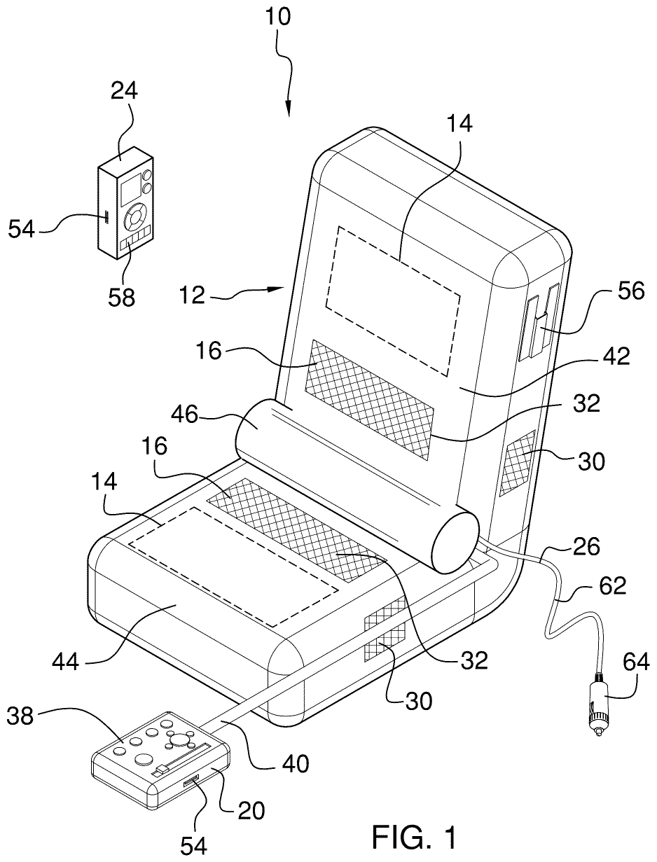

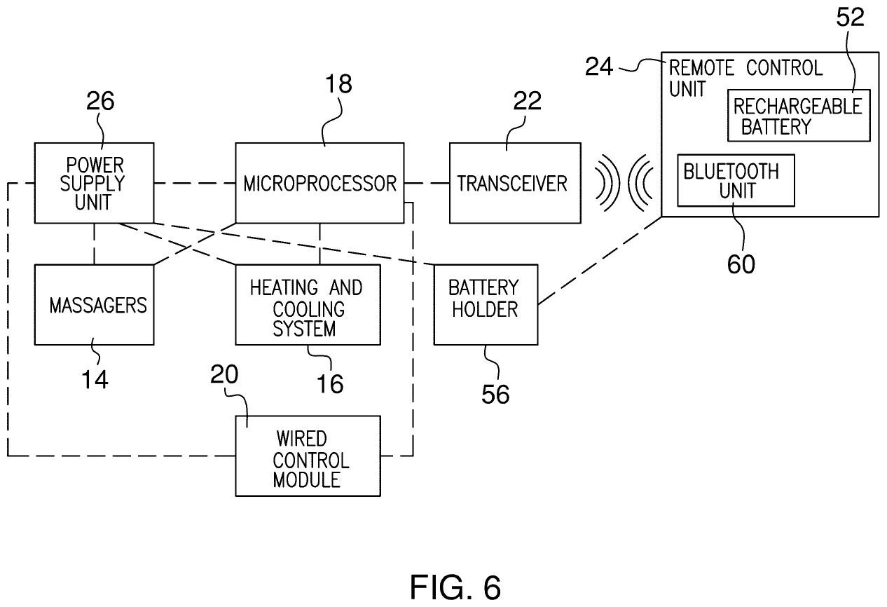

With reference now to the drawings, and in particular to FIGS. 1 through 6 thereof, a new massage seat embodying the principles and concepts of an embodiment of the disclosure and generally designated by the reference numeral 10 will be described.

As best illustrated in FIGS. 1 through 6, the massage seat 10 generally comprises a seat body 12, a plurality of massagers 14, a heating and cooling system 16, a microprocessor 18, a wired control module 20, a transceiver 22, a remote control module 24, and a power supply unit 26. The seat body 12 is designed to be placed on a vehicle seat 72 or a chair. The massagers 14 are positioned in the seat body 12. The heating and cooling system 16 includes air channels 28 positioned in the seat body 12 and each having an air inlet 30 and an air outlet 32, at least one fan 34 designed to circulate air through the air channels 28, and at least one heating element 36 designed to selectively heat the air in the air channels 28. The microprocessor 18 is connected to the massagers 14 and the heating and cooling system 16. The wired control module 20 includes a housing 38 and a cable 40 connecting the housing 38 to the seat body 12. The wired control module 20 is connected to the microprocessor 18 to selectively control the massagers 14 and the heating and cooling system 16. The transceiver 22 is connected to the microprocessor 18. The remote control module 24 is wirelessly connected to the microprocessor 18 by the transceiver 22 to selectively control the massagers 14 and the heating and cooling system 16. The power supply unit 26 is connected to the massagers 14, the heating and cooling system 16, the microprocessor 18, and the wired control module 20 to supply power.

As shown in FIG. 1, the seat body 12 includes a backrest portion 42, a seat portion 44, and a pivot portion 46 between the backrest portion 42 and the seat portion 44. The pivot portion 46 is designed to hold the backrest portion 42 and the seat portion 44 at an angle. The pivot portion 46 includes a rounded outer surface and a foam material. In one possible embodiment, the pivot portion 46 includes a positioning mechanism, such as a hinge with a set of arms extending into each of the backrest portion 42 and the seat portion 44, designed to selectively position the backrest portion 42 and the seat portion 44 at different angles. In the exemplary embodiment, the pivot portion 46 is a static joint with foam material to cushion a user seated on the seat body 12.

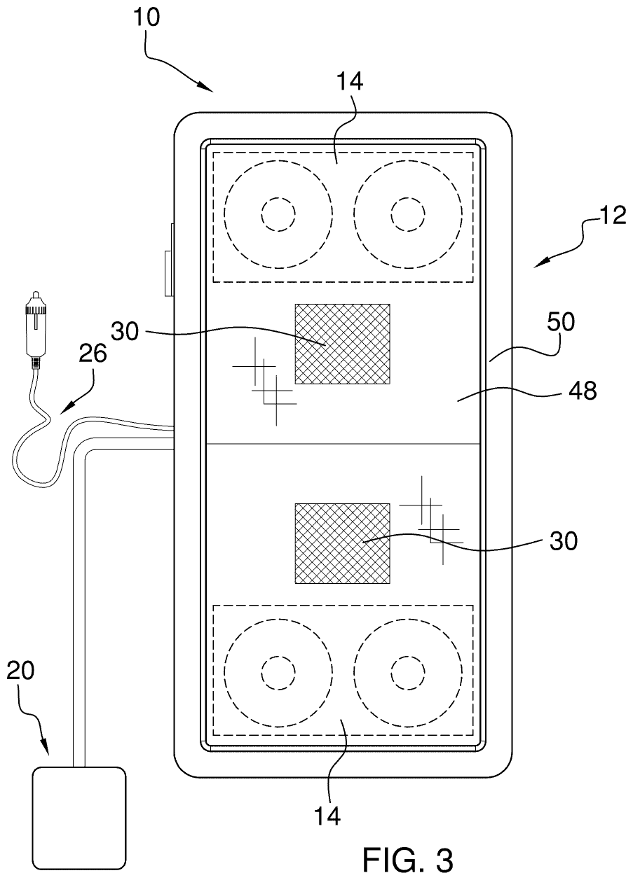

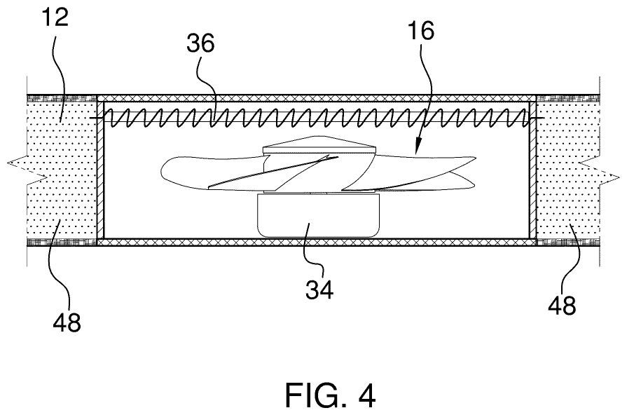

The seat body 12 includes a cushion layer 48, shown in FIG. 4, and an elastic edge 50, shown in FIG. 3. The elastic edge 50 extends about a perimeter of the seat body 12. The elastic edge 50 is designed to selectively removably couple the seat body 12 to the vehicle seat 72 or the chair. In another possible embodiment, the elastic edge 50 could include straps extending across the seat body 12 to further secure the seat body 12 to the vehicle seat 72 or the chair.

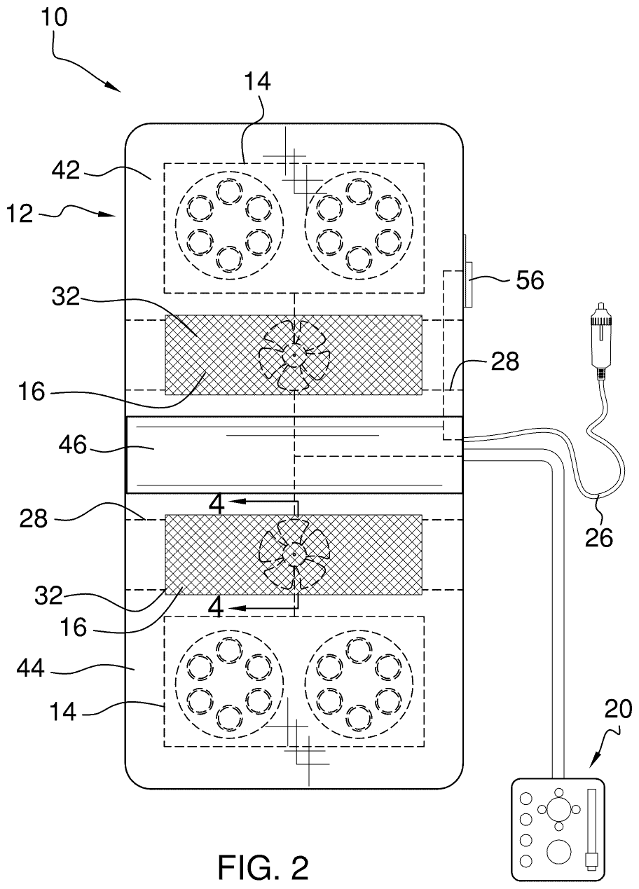

As shown in FIG. 2, at least one of the massagers 14 is positioned in the backrest portion 42 and at least one other of the massagers 14 is positioned in the seat portion 44. In the exemplary embodiment, two of the massagers 14 are positioned in each of the backrest portion 42 and the seat portion 44, though essentially any number or type of massager can be included as is well known in the massage device arts. Also as shown in FIG. 2, at least one of the air outlets 32 is positioned in the backrest portion 42 and at least one other of the air outlets 32 is positioned in the seat portion 44. In addition, a first fan 34 is positioned in the backrest portion 42 and a second fan 34 is positioned in the seat portion 44. Each of the fans 34 is individually controllable to provide air circulation to different parts of a user seated on the seat body 12. A first heating element 36, shown in FIG. 4, is positioned in the backrest portion 42 and a second heating element 36 positioned in the seat portion 44. Each of the heating elements 36 is individually controllable to provide heat to different parts of a user seated on the seat body 12. In the exemplary embodiment, the heating element 36 is a radiant electric element that can heat the air being circulated by the fan 34. However, other types of heating devices could be used as are well known in the heating arts. FIGS. 1 and 2 show one exemplary embodiment, and any number of air outlets 32 and heating elements 36 could be included in the backrest portion 42 and the seat portion 44. In the exemplary embodiment, the air inlets 30 are positioned in the sides (FIG. 1) and rear of the seat body 12 (FIG. 3), though the number and positioning can be varied as desired. The air outlets 32 and the air inlets 30 can be covered by a breathable fabric or mesh or plastic with openings.

The remote control module 24 includes a rechargeable battery 52. The remote control module 24 includes a charging port 54 designed to be connected to electronic devices to charge the electronic devices. The remote control module 24 can therefore be used for both controlling the operation of the massage seat 10, but can also be used as a charger for items like smart phones. In the exemplary embodiment in FIG. 1, like the remote control module 24, the wired control module 20 also includes a charging port 54 designed to be connected to electronic devices to charge the electronic devices. The charging port 54 could be a USB-style port, and there could be more than one charging port 54.

In the exemplary embodiment in FIG. 1, the massage seat 10 further includes a battery holder 56 that is attached to an outer surface of the seat body 12. The battery holder 56 is connected to the power supply unit 26. The battery holder 56 is connectable to the remote control module 24 to store the remote control module 24 and charge the rechargeable battery 52 of the remote control module 24.

In the exemplary embodiment in FIG. 1, the remote control module 24 includes a speaker 58 and a Bluetooth unit 60 designed to connect the remote control module 24 to a vehicle computer. The speaker 58 could be used for input of voice commands and to play audio, such as phone calls or music. In another possible embodiment, the wired control module 20 could similarly include a speaker 58 and a Bluetooth unit 60.

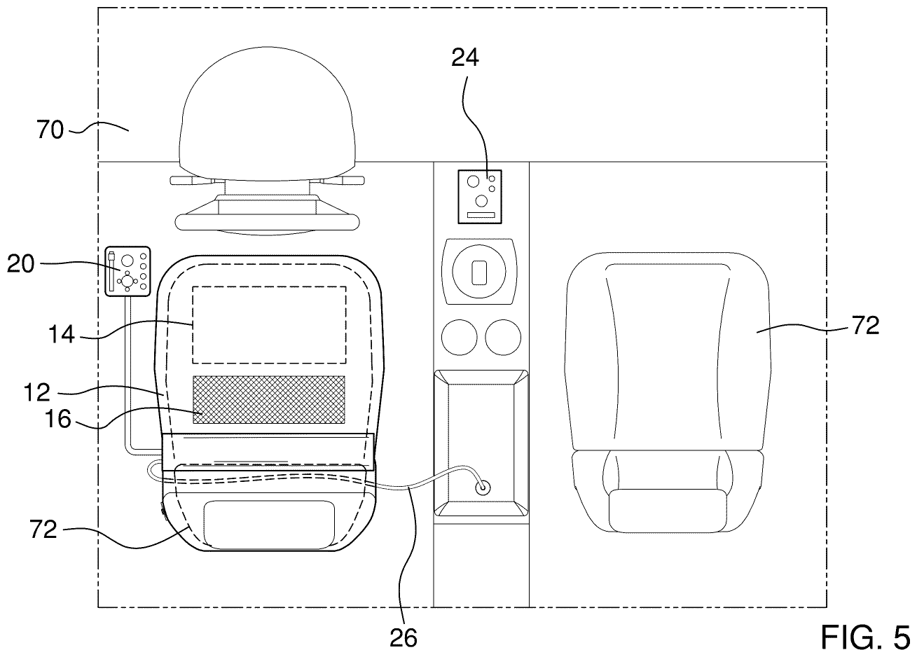

In use, the massage seat 10 can be placed over a vehicle seat 72 in a car 70, as shown in FIG. 5, though the massage seat 10 could also be placed on a chair, couch, or other type of furniture. The power supply unit 26, which includes a power cable 62 and a power connector 64, such as a plug to be inserted into a cigarette lighter or power receptacle, can be connected to the electrical system of the car. The user can then operate the various functions of the massage seat 10, such as heating, cooling, and massage, using either the wired control module 20 or the remote control module 24. Since the heating, cooling, and massage functions are individually controllable, the user can vary the operation of the massage seat 10, such as possibly providing heat in the backrest portion 42 and cooling in the seat portion 44 with high massage setting in the backrest portion 42 and low massage setting in the seat portion 44. Essentially any number of operating configurations are within the scope of the disclosure. The user can also selectively use any of the other features, such as charging personal electronic devices or playing music through the speaker 58.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massage seat comprising:
a seat body, said seat body being configured to be placed on a vehicle seat or a chair;
a plurality of massagers, said massagers being positioned in said seat body;
a heating and cooling system including:
air channels being positioned in said seat body, each of said air channels having an air inlet and an air outlet,
at least one fan being configured to circulate air through said air channels, and
at least one heating element being configured to selectively heat the air in said air channels;
a microprocessor, said microprocessor being connected to said massagers and said heating and cooling system;
a wired control module, said wired control module including a housing and a cable connecting said housing to said seat body, said wired control module being connected to said microprocessor to selectively control said massagers and said heating and cooling system;
a transceiver, said transceiver being connected to said microprocessor;
a remote control module, said remote control module being wirelessly connected to said microprocessor by said transceiver to selectively control said massagers and said heating and cooling system; and
a power supply unit, said power supply unit being connected to said massagers, said heating and cooling system, said microprocessor, and said wired control module to supply power.

2. The massage seat of claim 1, wherein:
said seat body includes a backrest portion, a seat portion, and a pivot portion between said backrest portion and said seat portion;
said pivot portion is configured to hold said backrest portion and said seat portion at an angle; and
said pivot portion includes a rounded outer surface and a foam material.

3. The massage seat of claim 2, wherein:
at least one of said massagers is positioned in said backrest portion and at least one other of said massagers is positioned in said seat portion; and
at least one of said air outlets is positioned in said backrest portion and at least one other of said air outlets is positioned in said seat portion.

4. The massage seat of claim 2, wherein said at least one fan includes a first fan positioned in said backrest portion and a second fan positioned in said seat portion, each of which is individually controllable.

5. The massage seat of claim 2, wherein said at least one heating element includes a first heating element positioned in said backrest portion and a second heating element positioned in said seat portion, each of which is individually controllable.

6. The massage seat of claim 1, wherein:
said seat body includes a cushion layer and an elastic edge;
said elastic edge extends about a perimeter of said seat body; and
said elastic edge is configured to selectively removably couple said seat body to the vehicle seat or the chair.

7. The massage seat of claim 1, wherein:
said remote control module includes a rechargeable battery; and
said remote control module includes a charging port configured to be connected to electronic devices to charge the electronic devices.

8. The massage seat of claim 1, further comprising a battery holder being attached to an outer surface of said seat body, said battery holder being connected to said power supply unit, said battery holder being connectable to said remote control module to store said remote control module and charge said rechargeable battery of said remote control module.

9. The massage seat of claim 1, wherein said wired control module includes a charging port configured to be connected to electronic devices to charge the electronic devices.

10. The massage seat of claim 1, wherein said remote control module includes a speaker and a Bluetooth unit configured to connect said remote control module to a vehicle computer.

11. The massage seat of claim 3, wherein said at least one fan includes a first fan positioned in said backrest portion and a second fan positioned in said seat portion, each of which is individually controllable.

12. The massage seat of claim 11, wherein said at least one heating element includes a first heating element positioned in said backrest portion and a second heating element positioned in said seat portion, each of which is individually controllable.

13. The massage seat of claim 12, wherein:
said seat body includes a cushion layer and an elastic edge;
said elastic edge extends about a perimeter of said seat body; and
said elastic edge is configured to selectively removably couple said seat body to the vehicle seat or the chair.

14. The massage seat of claim 13, wherein:
said remote control module includes a rechargeable battery; and
said remote control module includes a charging port configured to be connected to electronic devices to charge the electronic devices.

15. The massage seat of claim 14, further comprising a battery holder being attached to an outer surface of said seat body, said battery holder being connected to said power supply unit, said battery holder being connectable to said remote control module to store said remote control module and charge said rechargeable battery of said remote control module.

16. The massage seat of claim 15, wherein said wired control module includes a charging port configured to be connected to electronic devices to charge the electronic devices.

17. The massage seat of claim 16, wherein said remote control module includes a speaker and a Bluetooth unit configured to connect said remote control module to a vehicle computer.
